(19) United States
(12) Patent Application Publication
(10) Pub. No.: US 2009/0014595 A1
(43) Pub. Date: Jan. 15, 2009

(54) ELECTRICAL CONTROL SYSTEM FOR AN AIRCRAFT STEERING VANE

(75) Inventors: Christophe Rougelot, Toulouse (FR); Didier Ronceray, Pibrac (FR)

Correspondence Address: Dickinson Wright PLLC;James E. Ledbetter, Esq., International Square, 1875 Eye Street, N.W., Suite 1200, Washington, DC, 20006, US

(73) Assignee: AIRBUS FRANCE, TOULOUSE (FR)

(21) Appl. No.: 12/162,465

(22) PCT Filed: Feb. 19, 2007
(86) PCT No.: PCT/FR2007/000290

§ 371 Date: Jul. 28, 2008

(30) Foreign Application Priority Data
Feb. 27, 2006 (FR) 0601671

(51) Int. Cl. B64C 13/50

(52) U.S. Cl. 244/228

(57) ABSTRACT

The invention concerns a system (1) comprising a steering vane (2) which can turn within a rudder deflection range which is limited by first and second rudder deflection limits and means (12) for asymmetrically varying said first and second rudder deflection limits based on the current values of the aircraft flight parameters.

The present invention relates to an electric control system for a steering control surface of an aircraft, in particular a transport aircraft.

It is known that, in order to improve the performance (fuel consumption, noise level, etc.) of an aircraft without decreasing the payload transported, manufacturers are wont to decrease the mass of the aircraft as far as possible, that is to say the mass of the structure, of members, of equipment, etc. of said aircraft.

Accordingly, it may be beneficial to decrease the mass of stabilizer elements such as the fin (that is to say the fixed plane of the vertical empennage of the aircraft) which is intended to ensure the en-route stability of the aircraft and which carries the steering control surface (that is to say a movable flap which is mounted on the fin and which is maneuverable with the aim of modifying the direction of the aircraft). In a customary manner, a steering control surface is mounted rotatably about an axis so as to be able to take any angular deflection position inside a range of travel which is limited by a first and a second limits of travel (or first and second stops).

It is known that a stabilizer element of an aircraft is dimensioned by taking account of the maximum loads to which it is liable to be subjected during the various flight configurations of this aircraft. Consequently, in order to limit the mass of such a stabilizer element and hence also the mass of the aircraft, one solution is to reduce the loads to which this stabilizer element is liable to be subjected in the course of a flight.

Accordingly, document FR-2 809 373 from the Applicant discloses an electric control system for a steering control surface of an aircraft, by virtue of which it is possible to limit the lateral loadings applied to said steering control surface during maneuvers and hence to reduce the dimensioning and the mass of the latter, without however reducing the aircraft's flight qualities or flight safety.

To do this, said control system comprises:
a rudder bar actuated by the pilot and associated with a transducer delivering an electric piloting order representative of the action of the pilot on said rudder bar;
an actuator receiving a control order derived from said piloting order and moving said steering control surface about its axis of rotation; and
between said rudder bar and said actuator, filtering means of the low-pass type, receiving said piloting order from said transducer and devising said control order for said actuator, the time constant of said filtering means being all the higher as the amplitude of said piloting order corresponds to a larger fraction of the maximum value of travel of the steering control surface.

Thus, this known control system introduces, into the piloting orders to the rudder bar, a nonlinear filtering which depends on the travel available for the steering control surface, this filtering being all the greater as said steering control surface approaches the stops limiting the maximum travel, thereby limiting the loadings applied to said control surface and hence making it possible to reduce the dimensioning and the mass of the latter.

However, the adjustment of said filtering being identical over the whole of the flight domain of the aircraft, said filtering depends on conditions related to the control surface deflection order, but does not depend on the flight conditions of the aircraft.

On the other hand, document FR-2 844 251 from the Applicant discloses an electric control system for a control surface which makes it possible to limit to a maximum load the load to which a stabilizer element (such as a fin) is subjected, doing so whatever the flight conditions and maneuvers of the aircraft.

However, such a customary control system does not make it possible to profit from the maximum performance of the steering control surface under all conditions of displacement of the aircraft, and in particular when rolling on the ground, especially with a strong sidewind generating significant sideslip. Specifically, in such a situation, the steering control surface must not only guide the aircraft in accordance with the control order ordered by the pilot via the rudder bar, but also oppose this sidewind. Hence, because of the limits of travel (right and left) of the steering control surface, it can happen in such a situation that the steering control surface is brought to one of these limits of travel without however being able to completely achieve its objectives (relating to the control of the direction of the aircraft). This limit of travel thus attained of the range of travel is too low and therefore restricts in this situation the control of the direction of the aircraft, while the other limit of travel is never attained.

Consequently, a customary control system, such as the aforesaid, does not make it possible to always direct the aircraft in a completely satisfactory manner under all displacement conditions, in particular through strong sidewind on the ground.

The present invention relates to an electric control system for a steering control surface of an aircraft, which makes it possible to remedy the aforesaid drawbacks.

For this purpose, according to the invention, said system of the type comprising:
said steering control surface which is mounted rotatably about an axis so as to be able to take any angular deflection position inside a range of travel which is limited by a first and a second limits of travel;
a rudder bar which is capable of being actuated by a pilot of the aircraft and which is associated with a transducer which delivers a piloting order representative of the action of the pilot on said rudder bar;
a first means which determines, on the basis of said piloting order, by taking account of said first and second limits of travel, a deflection order making it possible to bring said steering control surface to a position situated between said first and second limits of travel and dependent on said piloting order; and
an actuator which receives this deflection order and which displaces said steering control surface about said axis as a function of said deflection order received,
   is noteworthy in that it comprises moreover:
a set of information sources capable of generating respectively the current values of flight parameters related to the aircraft; and
a second means for varying said first and second limits of travel, doing so at least partially in a dissymmetric manner, as a function of the current values of said flight parameters, before transmitting these first and second limits of travel to said first means.

Thus, by virtue of the invention, said first and second limits of travel are made to vary, doing so at least partially in a dissymmetric manner, as a function of the current values of said flight parameters which are representative of the conditions of displacement of the aircraft (as specified below). Consequently, it is possible to adapt the range of travel of the steering control surface (and thus the effectiveness of the latter) to said actual displacement conditions.

Although not exclusively, the control system in accordance with the invention is particularly advantageous when the aircraft is rolling on the ground and is subjected to a strong sidewind. In this case, said control system can be formed in such a way as to displace one of the limits of travel (namely that which is on the side allowing the steering control surface to oppose said sidewind) more in such a way as to increase the range of travel of the steering control surface more on the side of this limit of travel than on the other side, thereby making it possible to increase the effectiveness of the directional control of the aircraft in this situation and to limit the loadings on the other side.

In a particular embodiment, said set of information sources comprises at least some of the following means:
a means for determining the phase of displacement of the aircraft;
a means for determining the speed of the aircraft;
a means for determining the Mach number of the aircraft;
a means for determining the altitude of the aircraft;
a means for determining the aerodynamic configuration of the aircraft;
a means for determining the angle of sideslip of the aircraft;
a means for determining the thrust generated by the engines of the aircraft;
a means for determining interactions between deflections of various control surfaces of the aircraft; and
a means for determining the yaw rate of the aircraft.

Furthermore, advantageously:
said second means comprises a database containing curves of variations of said first and second limits of travel as a function of values of said flight parameters; and/or
said first and second means form part of a calculation unit.

The figures of the appended drawing will elucidate the way in which the invention may be achieved. In these figures, identical references designate similar elements.

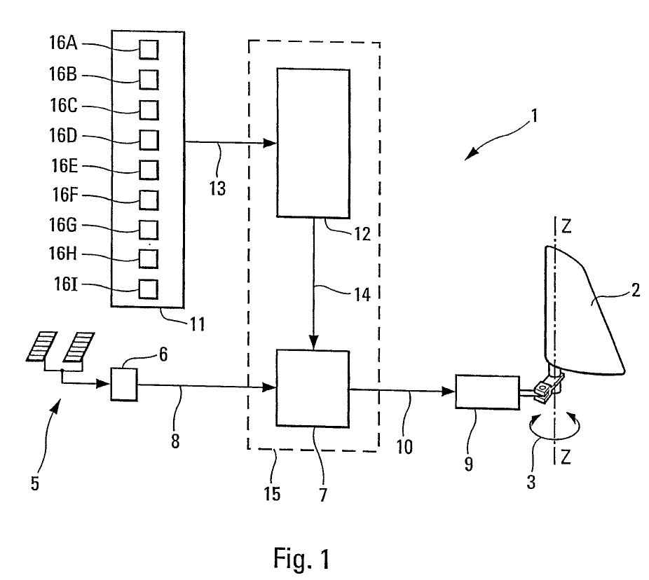

FIG. 1 is the schematic diagram of a control system in accordance with the invention.

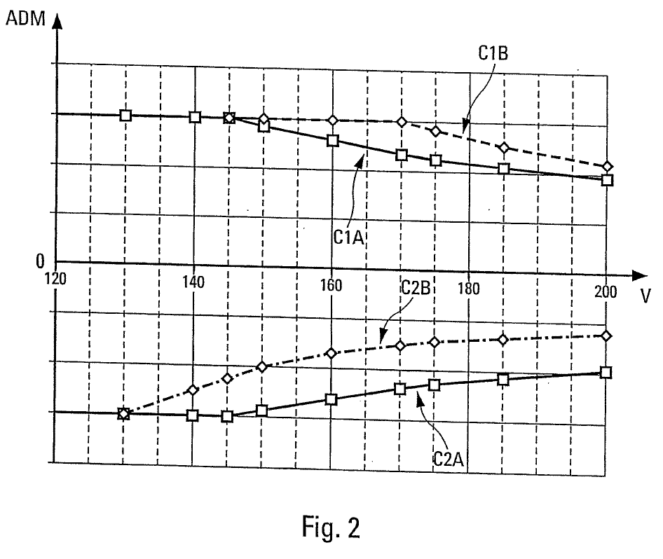

FIG. 2 is a graphic illustrating variations in the limits of travel of the range of travel of a steering control surface, under particular displacement conditions of the aircraft.

The electric control system 1, in accordance with the present invention and schematically represented in FIG. 1, is intended for the actuation of a steering control surface 2 of an aircraft, which is mounted rotatably in the two senses about a vertical axis Z-Z, in the manner symbolized by a double arrow 3. Said steering control surface 2 can take any angular position about said axis Z-Z inside a range of travel, which extends on either side of an aerodynamically neutral position of said steering control surface 2 and which is limited by a first limit of travel L1 and by a second limit of travel L2.

Said electric control system 1 of an aircraft, for example of a transport aircraft, is of the known type, comprising:
a rudder bar 5 which is capable of being actuated by a pilot of the aircraft, and which is associated with a transducer 6 delivering an electric control order (relating to the deflection of the steering control surface 2) representative of the actuation of said rudder bar 5;
a calculation means 7 which is connected by way of an electric link 8 to said transducer 6 and which is intended to determine, on the basis of said piloting order received, by taking account of said first and second limits of travel L1 and L2, a deflection order making it possible to bring said steering control surface 2 to a position situated between said first and second limits of travel L1 and L2 and dependent on said piloting order; and
a customary actuator 9, which receives this deflection order by way of an electric link 10 and which displaces said steering control surface 2 about said axis Z-Z, as a function of said deflection order received.

According to the invention, said system 1 comprises moreover:
a set 11 of information sources specified below, which are capable of generating respectively the current values of flight parameters. These flight parameters are related to the aircraft and are representative of the actual displacement conditions of said aircraft; and
a means 12 which is connected by way of a link 13 to said set 11 and which is formed in such a way as:
   to vary said first and second limits of travel L1 and L2, doing so at least partially in a dissymmetric manner, as a function of the current values of said flight parameters, received from said set 11 of information sources; and
   to transmit the new limit values of travel L1 and L2 to said means 7 by way of a link 14 so that the latter uses them to determine the deflection order intended for the actuator 9.

Thus, the system 1 in accordance with the invention varies said first and second limits of travel L1 and L2, doing so at least partially in a dissymmetric manner, as a function of the current values of flight parameters which are representative of the conditions of displacement of the aircraft. Consequently, said system 1 makes it possible to adapt the range of travel of the steering control surface 2 (and thus the effectiveness of the latter) to said actual displacement conditions.

Although not exclusively, the system 1 in accordance with the invention is particularly advantageous when the aircraft is rolling on the ground and is subjected to a strong sidewind. In this case, said system 1 displaces one of the limits of travel (namely that which is on the side allowing the steering control surface 2 to oppose said sidewind) more in such a way as to increase the range of travel of the steering control surface 2 more on the side of this limit of travel than on the other side, thereby making it possible to increase the effectiveness of the directional control of the aircraft in this situation and to limit the loadings on the other side.

In a particular embodiment, said means 7 and 12 form part of a calculation unit 15.

Furthermore, said means 12 can comprise a database (not represented) containing curves of variation C1 and C2 of said limits of travel L1 and L2 as a function of the current values of a plurality of flight parameters.

In a first variant embodiment, said variation curves are determined in an empirical manner, while in a second variant embodiment, said variation curves are determined with the aid of mathematical formulae in which said current values of the flight parameters are integrated.

By way of illustration, represented in FIG. 2 is an angle of maximum travel ADM (expressed for example in degrees) with respect to a neutral position, representing said limits of travel L1 and L2, as a function of the speed V (expressed in knots, a knot being equal to about 0.5 m/s) of the aircraft and of its angle of sideslip β. More precisely:
curves C1A and C2A illustrate the variations respectively of said limits of travel L1 and L2 as a function of the speed V, for a negligible angle of sideslip β. These curves C1A and C2A are represented by solid lines and some of their values are highlighted by squares; and
curves C1B and C2B illustrate the variations respectively of said limits of travel L1 and L2 as a function of the speed V, for a significantly positive angle of sideslip β. These curves C1B and C2B are represented by broken lines and some of their values are highlighted by diamonds.

This FIG. 2 clearly highlights the possibilities (at least partial) of asymmetric variations in said limits of travel L1 and L2 as a function of the current values of flight parameters, in this instance the speed V and the angle of sideslip β. Thus, the variation curves C1B and C2B are asymmetric. On the other hand, the variation curves C1A and C2A remain, for their part, symmetric.

Additionally, in a particular embodiment, said set 11 of information sources comprises at least some of the following customary means:
a means 16A for determining the phase of displacement of the aircraft. This may be a flight phase (climb phase, cruising flight phase, etc.) or a ground rolling phase, for example with a view to a takeoff or following a landing;
a means 16B for determining the speed of the aircraft;
a means 16C for determining the Mach number of the aircraft;
a means 16D for determining the altitude of the aircraft;
a means 16E for determining the aerodynamic configuration of the aircraft;
a means 16F for determining the angle of sideslip β of the aircraft. This angle of sideslip β can, for example, be measured at the level of the center of gravity of the aircraft, at the level of the fin or at the level of the nose of the aircraft;
a means 16G for determining the thrust generated by the engines of the aircraft;
a means 16H for determining the interactions between the deflections of the various control surfaces (tailplane, elevators, spoilers) of the aircraft; and
a means 16I for determining the yaw rate of the aircraft.

In a first variant, said means 12 uses the current values of some of the aforesaid flight parameters (displacement phase, speed, Mach number, altitude, aerodynamic configuration, angle of sideslip, thrust, interaction between the deflections of the various control surfaces, yaw rate), while in a second variant, said means 12 simultaneously uses the current values of all these flight parameters.

1-5. (canceled)

6. An electric control system for a steering control surface of an aircraft, said system (1) comprising:
said steering control surface (2) which is mounted rotatably about an axis (Z-Z) so as to be able to take any angular deflection position inside a range of travel which is limited by a first and a second limits of travel;
a set (11) of information sources capable of generating respectively the current values of flight parameters related to the aircraft;
a rudder bar (5) which is capable of being actuated by a pilot of the aircraft and which is associated with a transducer (6) which delivers a piloting order representative of the action of the pilot on said rudder bar (5);
a first means (7) which determines, on the basis of said piloting order, by taking account of said first and second limits of travel, a deflection order making it possible to bring said steering control surface (2) to a position situated between said first and second limits of travel and dependent on said piloting order; and
an actuator (9) which receives this deflection order and which displaces said steering control surface (2) about said axis (Z-Z) as a function of said deflection order received,
wherein it comprises, moreover, a second means (12) for varying, as a function of the current values of said flight parameters which are representative of actual displacement conditions of the aircraft, said first and second limits of travel, doing so at least partially in a dissymmetric manner, so as to adapt the range of travel of the steering control surface (2) to said actual displacement conditions of the aircraft, and for transmitting these first and second limits of travel to said first means (7).

7. The system as claimed in claim 6, wherein said set (11) of information sources comprises at least some of the following means:
a means (16A) for determining the phase of displacement of the aircraft;
a means (16B) for determining the speed of the aircraft;
a means (16C) for determining the Mach number of the aircraft;
a means (16D) for determining the altitude of the aircraft;
a means (16E) for determining the aerodynamic configuration of the aircraft;
a means (16F) for determining the angle of sideslip of the aircraft;
a means (16G) for determining the thrust generated by the engines of the aircraft;
a means (16H) for determining interactions between deflections of various control surfaces of the aircraft; and
a means (16I) for determining the yaw rate of the aircraft.

8. The system as claimed in claim 6, wherein said second means (12) comprises a database containing curves of variations of said first and second limits of travel as a function of values of said flight parameters.

9. The system as claimed in claim 6, wherein said first and second means (7, 12) form part of a calculation unit (15).

10. An aircraft, wherein it comprises a control system (1) such as that specified under claim 6.
